(19) United States
(12) Patent Application Publication
(10) Pub. No.: US 2026/0014702 A1
(43) Pub. Date: Jan. 15, 2026

(54) ROBOT SIMULATION DEVICE

(71) Applicant: Fanuc Corporation, Minamitsuru-gun, Yamanashi (JP)

(72) Inventor: Hiroyuki YONEYAMA, Minamitsuru-gun, Yamanashi (JP)

(73) Assignee: Fanuc Corporation, Minamitsuru-gun, Yamanashi (JP)

(21) Appl. No.: 18/881,865

(22) PCT Filed: Oct. 7, 2022
(86) PCT No.: PCT/JP2022/037684

§ 371 Date: Jan. 7, 2025

(51) Int. Cl. B25J 9/16; B25J 9/00

(52) U.S. Cl. CPC B25J 9/1671; B25J 9/0093; G05B 2219/39001

(57) ABSTRACT

A robot simulation device including: a three-dimensional model arrangement part for arranging, in a virtual space, a robot three-dimensional model, a robot-installed hand three-dimensional model, a supply device three-dimensional model, an ejection device three-dimensional model, workpiece three-dimensional models, and a detection device three-dimensional model for detecting a workpiece on the supply device; a gripping workpiece quantity designation part for receiving input designating a quantity of workpiece three-dimensional models to be gripped at once by the hand three-dimensional model; a reference workpiece designation part for receiving input designating a workpiece three-dimensional model; and a gripping position setting part for setting workpiece three-dimensional model gripping positions for the hand three-dimensional model relative to the workpiece three-dimensional models for when gripping the workpiece three-dimensional models with the hand three-dimensional model.

### CROSS REFERENCE TO RELATED APPLICATIONS

This is the U.S. National Phase application of PCT/JP2022/037684, filed Oct. 7, 2022, the disclosure of this application being incorporated herein by reference in its entirety for all purposes.

### FIELD OF THE INVENTION

The present disclosure relates to a robot simulation device.

### BACKGROUND OF THE INVENTION

A robot system configured to continuously pick up, by a robot, workpieces conveyed on a conveyance device such as a belt conveyor, and move the workpieces so as to arrange the workpieces on another conveyance device, a worktable, or the like has been known. Further, a robot simulation device that can simulate the operation of such a robot system has also been known.

PTL 1 describes an actual robot system for arranging or transferring articles by a robot. PTL 2 describes a programming device that simulates the work of loading, by using a robot including an adsorption hand, a pallet with articles arriving by conveyance on a conveyor. PTL 3 describes a simulation device that simulates the operation of moving a workpiece from a conveyance surface of a supply device to a receiving surface of a receiving device by a robot.

### PATENT LITERATURE

[PTL 1] Japanese Unexamined Patent Publication (Kokai) No. 2016-026899 A
[PTL 2] Japanese Unexamined Patent Publication (Kokai) No. 2009-070078 A
[PTL 3] Japanese Unexamined Patent Publication (Kokai) No. 2020-199625 A

### SUMMARY OF THE INVENTION

There is a case where, in a robot system configured to pick up a workpiece by a hand mounted on a robot, the robot is controlled to perform work for collectively picking up a plurality of workpieces by the hand. Therefore, a simulation device that is able to simulate the operation of a robot for collectively holding a plurality of workpieces by a hand is desired.

According to an aspect of the present disclosure, a robot simulation device includes: a three-dimensional model arrangement unit configured to arrange, in a virtual space, a three-dimensional model of a robot, a three-dimensional model of a hand mounted on the robot, a three-dimensional model of a supply device, a three-dimensional model of a discharge device, a three-dimensional model of a workpiece, and a three-dimensional model of a detection device that detects the workpiece on the supply device; a workpiece holding quantity designation unit configured to accept an input for designating a quantity of three-dimensional models of workpieces collectively held by the three-dimensional model of the hand; a reference workpiece designation unit configured to accept an input for designating a three-dimensional model of a workpiece serving as a reference when the three-dimensional model of the workpiece is held by the three-dimensional model of the hand; and a holding position setting unit configured to set a holding position of the three-dimensional model of the workpiece with respect to the three-dimensional model of the hand when the three-dimensional model of the workpiece is held by the three-dimensional model of the hand, based on the designated quantity of the three-dimensional model of the workpiece being collectively held, the three-dimensional model of the workpiece serving as the reference, an interval between three-dimensional models of workpieces on the three-dimensional model of the supply device, and a position and a posture of the three-dimensional model of the robot when moving onto the three-dimensional model of the supply device.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is a drawing illustrating a specific example of a robot simulation device according to an embodiment.

FIG. 2 is a functional block diagram of the robot simulation device.

FIG. 3 is a flowchart of a simulation of a workpiece picking-up operation of collectively holding and transferring three-dimensional models of workpieces.

FIG. 4 is a diagram illustrating a three-dimensional model of a robot system displayed on a display screen by a three-dimensional model arrangement unit.

FIG. 5 is a diagram illustrating a first example relating to designation of the quantity of workpiece models being collectively held and a workpiece model serving as a reference.

FIG. 6 is a diagram illustrating a second example relating to designation of the quantity of workpiece models being collectively held and a workpiece model serving as a reference.

FIG. 7 is a diagram illustrating a third example relating to designation of the quantity of workpiece models being collectively held and a workpiece model serving as a reference.

FIG. 8 is a diagram illustrating setting of an interval between the three-dimensional models of the workpieces arranged on a conveyance device.

FIG. 9 is a diagram illustrating a simulation screen of a state where a three-dimensional model of a robot has moved on a three-dimensional model of a supply device.

FIG. 10 is a diagram illustrating a simulation screen of a state where the three-dimensional models of the plurality of workpieces are collectively held by a three-dimensional model of a hand.

FIG. 11 is a diagram illustrating a simulation screen of a state where the three-dimensional model of the robot moves on a three-dimensional model of a discharge device.

FIG. 12 is a diagram illustrating a simulation screen of a state where the three-dimensional models of the plurality of workpieces are arranged on the three-dimensional model of the discharge device by the three-dimensional model of the hand.

FIG. 13 is a diagram illustrating a simulation screen of a state where the three-dimensional models of the plurality of workpieces are arranged on a fixed stand serving as the discharge device by the three-dimensional model of the hand.

FIG. 14 is a diagram illustrating a simulation screen of a state where the three-dimensional models of the plurality of workpieces are collectively held from a fixed stand serving as the supply device by the three-dimensional model of the hand.

### DETAILED DESCRIPTION OF EMBODIMENTS OF THE INVENTION

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

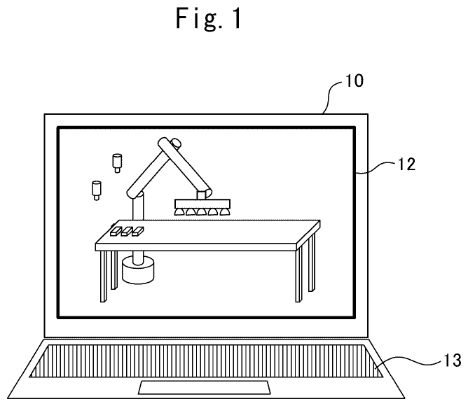

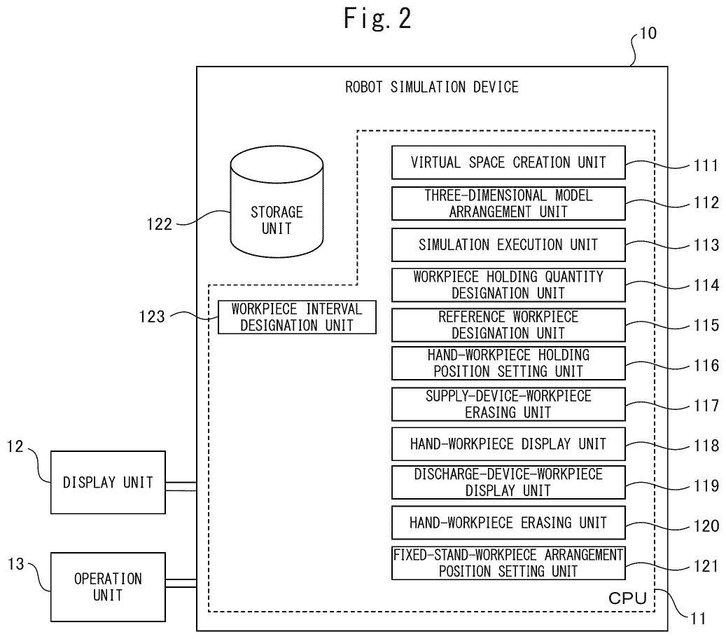

FIG. 1 is a drawing illustrating an example of robot simulation device 10 according to an embodiment. FIG. 2 is a functional block diagram of robot simulation device 10. Robot simulation device 10 is formed of an information processing device such as a personal computer and a tablet terminal. Robot simulation device 10 provides a function of executing a simulation of the operation of collectively holding three-dimensional models of a plurality of workpieces on a supply device that supplies workpieces by a three-dimensional model of a hand mounted on a three-dimensional model of a robot.

In the present specification, a device on a side that supplies a workpiece to a robot is referred to as a supply device, and a device on a side to which the workpiece picked up by the robot is transferred is referred to as a discharge device. The supply device may be a conveyance device such as a belt conveyor, or may be a fixed stand such as a table. Also, the discharge device may be a conveyance device such as a belt conveyor, or may be a fixed stand such as a table.

In the present specification, a simulation is assumed to include a simulation in which numerical calculation of a position and a posture of a robot and each of other apparatuses in addition to a simulation in which a three-dimensional model of each apparatus is caused to perform a simulated motion on a display screen (virtual space).

As illustrated in FIG. 1, robot simulation device 10 includes display unit 12 that displays various images related to a simulation, and operation unit 13 for performing various operation inputs by an operator. Display unit 12 includes, for example, a liquid crystal display. Operation unit 13 includes, for example, an input device such as a keyboard, a mouse, and a touch pad. The three-dimensional model of the robot and the like is stored in storage device 14 (FIG. 2). Robot simulation device 10 may have a configuration as a general computer in which a memory (such as a ROM, a RAM, and a non-volatile memory), display unit 12, operation unit 13, the storage device (such as an HDD), a network interface, various input/output interfaces, and the like are connected to CPU 11 (FIG. 2).

As illustrated in FIG. 2, robot simulation device 10 includes virtual space creation unit 111, three-dimensional model arrangement unit 112, simulation execution unit 113, workpiece holding quantity designation unit 114, reference workpiece designation unit 115, hand-workpiece holding position setting unit 116, supply-device-workpiece erasing unit 117, hand-workpiece display unit 118, discharge-device-workpiece display unit 119, and hand-workpiece erasing unit 120. Robot simulation device 10 may further include fixed-stand-workpiece arrangement position setting unit 121. Robot simulation device 10 may further include workpiece interval designation unit 123. The functional blocks may be achieved by CPU 11 of robot simulation device 10 executing software.

Robot simulation device 10 includes storage unit 122. Storage unit 122 may be formed of a non-volatile memory or a storage device such as an HDD, for example. Storage unit 122 stores a three-dimensional model and arrangement information about each object constituting a robot system model, various types of setting information needed for executing a simulation, and the like.

Virtual space creation unit 111 generates a virtual space for arranging three-dimensional models of various objects constituting the robot system model in a memory space of the robot simulation device 10.

Three-dimensional model arrangement unit 112 arranges, on the virtual space, the three-dimensional model of the robot, a three-dimensional model of a conveyance device, a three-dimensional model of a workpiece, a three-dimensional model of a detection device, and a three-dimensional model of a fixed stand, based on arrangement information about various objects constituting the robot system model.

Simulation execution unit 113 has a function of simulating the operation of picking up a workpiece on the supply device by the three-dimensional model of the robot and transferring the workpiece to the discharge device. The function of simulation execution unit 113 includes a function of performing numerical calculation on a position and a posture of the three-dimensional models of the robot and various objects, and a function of causing the three-dimensional models of the robot and various objects to perform the simulated motion. Simulation execution unit 113 may be configured to control each functional block (the hand-workpiece holding position setting unit 116, the supply-device-workpiece erasing unit 117, the hand-workpiece display unit 118, the discharge-device-workpiece display unit 119, the hand-workpiece erasing unit 120, and the fixed-stand-workpiece arrangement position setting unit 121) relating to execution of a simulation.

Workpiece holding quantity designation unit 114 provides a function for designating the quantity of workpieces collectively held by the three-dimensional model of the hand. Workpiece holding quantity designation unit 114 may be configured to accept an input for setting the number of workpieces collectively held by the three-dimensional model of the hand via a setting screen (user interface). Alternatively, workpiece holding quantity designation unit 114 may receive, from an external device, an input of the quantity of workpieces being collectively held.

Reference workpiece designation unit 115 provides a function for designating a workpiece serving as a reference when the three-dimensional model of the workpiece is held by the three-dimensional model of the hand. Reference workpiece designation unit 115 may be configured to accept an input for designating a workpiece serving as a reference when the three-dimensional model of the workpiece is held by the three-dimensional model of the hand via a setting screen (user interface). Alternatively, reference workpiece designation unit 115 may receive, from an external device, an input for designating a three-dimensional model of a workpiece serving as a reference.

Hand-workpiece holding position setting unit 116 provides a function for setting a position of the three-dimensional model of the workpiece with respect to the three-dimensional model of the hand when the three-dimensional model of the workpiece is held by the three-dimensional model of the hand.

Supply-device-workpiece erasing unit 117 provides a function of erasing the three-dimensional model of the workpiece on the three-dimensional model of the supply device.

Hand-workpiece display unit 118 provides a function of displaying the three-dimensional model of the workpiece on the three-dimensional model of the hand.

Discharge-device-workpiece display unit 119 provides a function of displaying the three-dimensional model of the workpiece on the three-dimensional model of the discharge device.

Hand-workpiece erasing unit 120 provides a function of erasing the three-dimensional model of the workpiece on the three-dimensional model of the hand.

Supply-device-workpiece erasing unit 117, hand-workpiece display unit 118, discharge-device-workpiece display unit 119, and hand-workpiece erasing unit 120 may be configured to cooperate with simulation execution unit 113, and provide functions thereof in response to an instruction from simulation execution unit 113.

Fixed-stand-workpiece arrangement position setting unit 121 provides a function of setting an arrangement position of the three-dimensional model of the workpiece with respect to the three-dimensional model of the fixed stand when the fixed stand is used as the discharge device.

Workpiece interval designation unit 123 provides a function for designating an interval between the three-dimensional models of the plurality of workpieces arranged on the supply device. Workpiece interval designation unit 123 may be configured to accept an input for designating an interval between the three-dimensional models of the workpieces via a setting screen (user interface). Alternatively, workpiece interval designation unit 123 may receive, from an external device, an input for designating an interval between the three-dimensional models of the workpieces.

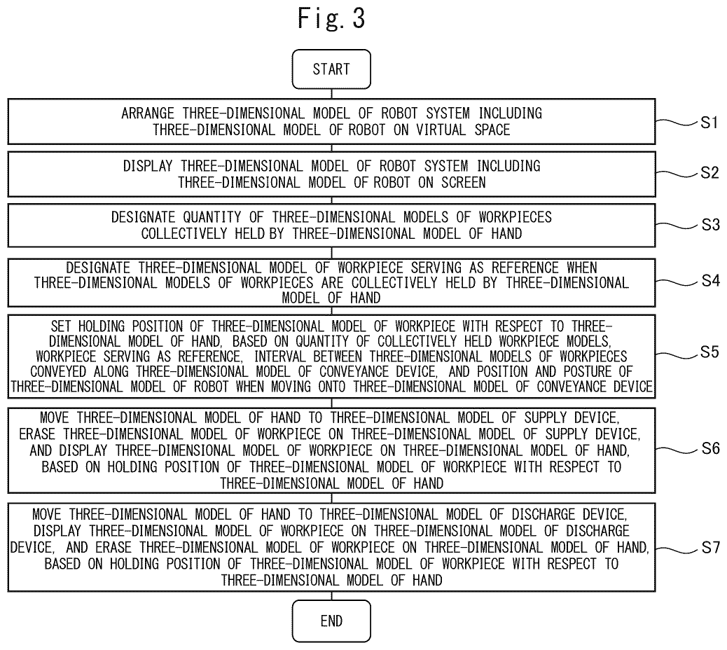

FIG. 3 is a flowchart illustrating a simulation of the operation (hereinafter described as a workpiece picking-up operation) of collectively holding and transferring three-dimensional models of workpieces, which is executed on the robot simulation device 10. The workpiece picking-up motion illustrated in FIG. 3 is performed under control by CPU 11 of robot simulation device 10.

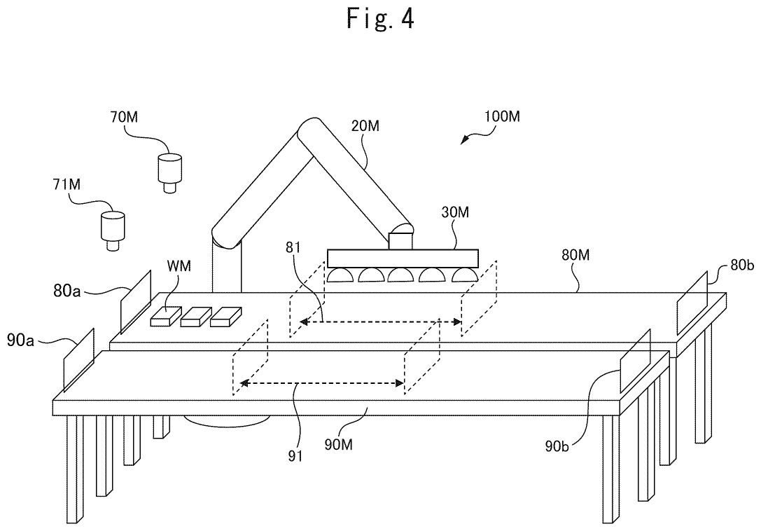

First, three-dimensional model arrangement unit 112 arranges a three-dimensional model of a robot system including a three-dimensional model of a robot on a virtual space (step S1). Then, three-dimensional model arrangement unit 112 displays, on a display screen of display unit 12, the three-dimensional model of the robot system arranged on the virtual space (step S2). FIG. 4 illustrates a three-dimensional model (hereinafter described as robot system model 100M) of a robot system displayed on the display screen by three-dimensional model arrangement unit 112. Robot system model 100M includes a three-dimensional model (hereinafter described as robot model 20M) of a robot, a three-dimensional model (hereinafter described as hand model 30M) of a hand, a three-dimensional model (hereinafter described as conveyance device model 80M) of a conveyance device as a supply device, a three-dimensional model (hereinafter described as workpiece model WM) of a workpiece, three-dimensional models (hereinafter described as detection device models 70M and 71M) of two detection devices, and a three-dimensional model (hereinafter described as conveyance device model 90M) of a conveyance device as a discharge device. The conveyance device is, for example, a belt conveyor.

In the present example, a model of a vertical articulated robot is used as robot model 20M, but a model of a robot of other types such as a horizontal articulated robot and a parallel link robot may be used.

Hand model 30M is a model of an adsorption hand as an exemplification, and includes a plurality of adsorption portions for collectively holding a plurality of workpieces. As hand model 30M, a three-dimensional model of a hand device of another type that can collectively hold a plurality of workpieces may be used.

Conveyance device model 80M conveys workpiece model WM at a fixed speed from an upstream side to a downstream side in a workpiece supply range between end portion 80a on the upstream side and end portion 80b on the downstream side. Robot model 20M performs an operation in such a way as to hold workpiece model WM by tracking a movement of workpiece model WM conveyed by conveyance device model 80M in a tracking operation range (indicated by an arrow 81 of a broken line) virtually defined on conveyance device model 80M.

Conveyance device model 90M can convey workpiece model WM at a fixed speed from the upstream side to the downstream side in a workpiece supply range between end portion 90a on the upstream side and end portion 90b on the downstream side. Robot model 20M performs an operation in such a way as to arrange workpiece model WM on conveyance device model 90M by tracking a movement of conveyance device model 90M in a tracking operation range (indicated by an arrow 91 of a broken line) virtually defined on conveyance device model 90M.

Setting information about conveyance device models 80M and 90M such as a conveyance speed and a conveyance direction may be preset in storage unit 122 or can be set to robot simulation device 10 by an operator. Robot simulation device 10 conveys workpiece model WM, based on the setting information about conveyance device models 80M and 90M.

Each of detection device models 70M and 71M is a model of a visual sensor. The visual sensor may be a camera that captures a gray-scale image or a color image, or may be a stereo camera or a three-dimensional sensor that can acquire a distance image and a three-dimensional point group. A positional relationship between detection device models 70M and 71M and robot model 20M is assumed to be already known. Detection device model 70M is arranged in such a way as to include the vicinity of the upstream end portion of the conveyance device model 80M in a capturing range. Detection device model 70M provides a function of detecting a position of workpiece model WM conveyed to the end portion on the upstream side of conveyance device model 80M by image processing on a captured image. Detection device model 71M may have a function of performing detection, checking, and the like on workpiece model WM conveyed on conveyance device model 90M. A detection result by detection device models 70M and 71M can be used in a simulation by simulation execution unit 113.

Returning to FIG. 3, next, workpiece holding quantity designation unit 114 accepts designation of the quantity of workpiece models WM collectively held by hand model 30M (step S3). The reference workpiece designation unit 115 accepts designation of a workpiece model serving as a reference when the workpiece models are collectively held by hand model 30M (step S4). The workpiece model serving as a reference is used as a reference when detection, calculation of a position, and the like of a workpiece model serving as a holding target are performed. An operator can designate a specific workpiece model conveyed on conveyance device model 80M as a “workpiece model serving as a reference”.

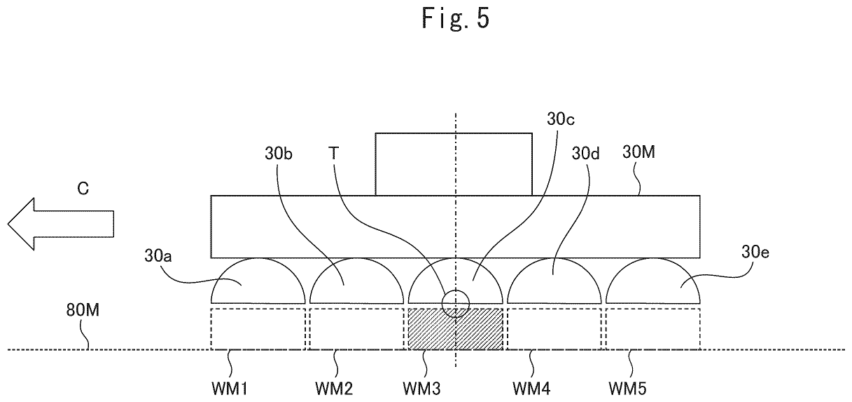

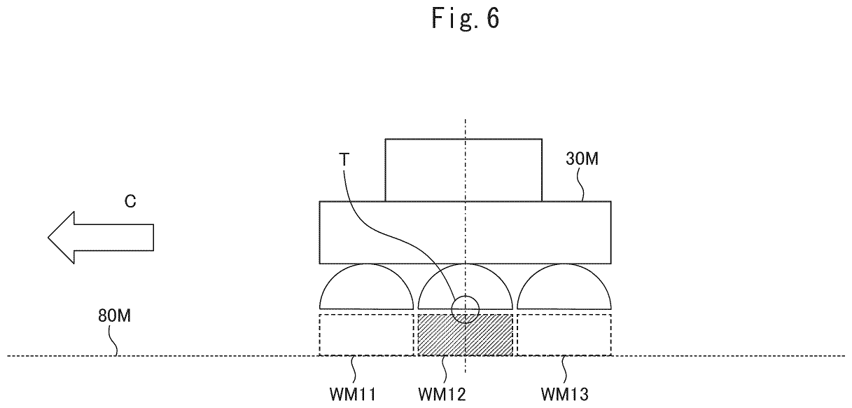

FIG. 5 is a diagram illustrating a first example relating to the designation of the quantity of workpiece models being collectively held and a workpiece model serving as a reference. As illustrated in FIG. 5, when hand model 30M is a type including five adsorption portions (30a, 30b, 30c, 30d, and 30e), the quantity of workpiece models collectively held by hand model 30M may be designated as five. An arrow C in FIG. 5 (and FIGS. 6 to 8) indicates the upstream side in a conveyance direction of conveyance device model 80M. As one example, an operator may designate, as a workpiece model serving as a reference, an n-th workpiece model from the upstream side among the plurality of workpiece models WM continuously conveyed on conveyance device model 80M. FIG. 5 illustrates a case where the third workpiece model (workpiece model WM3) from the upstream side among five workpiece models WM1 to WM5 conveyed on conveyance device model 80M is designated as a workpiece model serving as a reference.

For example, robot model 20M may perform the operation in such a way as to hold workpiece model WM3 serving as the reference at the position of a tool tip point T set on hand model 30M.

FIG. 6 is a diagram illustrating a second example relating to the designation of the quantity of workpiece models being collectively held and a workpiece model serving as a reference. As illustrated in FIG. 6, when hand model 30M is a type including three adsorption portions, the quantity of workpiece models collectively held by hand model 30M may be designated as three. FIG. 6 illustrates a case where the second workpiece model (workpiece model WM12) from the upstream side among three workpiece models WM11 to WM13 continuously conveyed on conveyance device model 80M is designated as a workpiece model serving as a reference.

In this case, for example, robot model 20M may perform the operation in such a way as to hold workpiece model WM12 serving as the reference at the position of the tool tip point T set on hand model 30M.

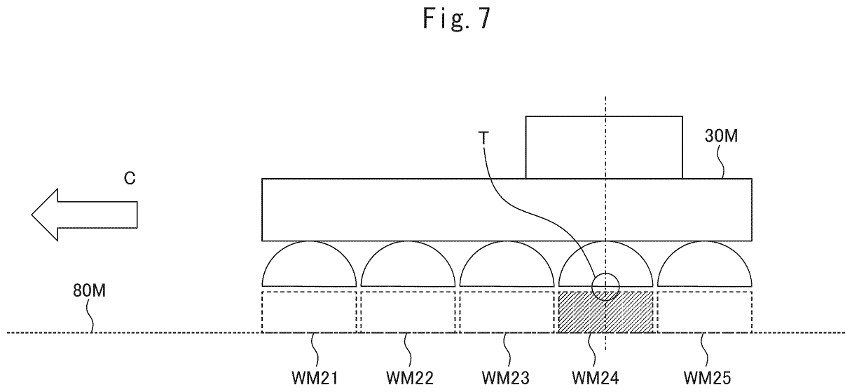

FIG. 7 is a diagram illustrating a third example relating to the designation of the quantity of workpiece models being collectively held and a workpiece model serving as a reference. As illustrated in FIG. 7, when hand model 30M is a type including five adsorption portions, the quantity of workpiece models collectively held by hand model 30M may be designated as five. FIG. 7 illustrates a case where the fourth workpiece model (workpiece model WM24) from the upstream side among five workpiece models WM21 to WM25 continuously conveyed on conveyance device model 80M is set as a workpiece model serving as a reference.

In this case, for example, robot model 20M may perform the operation in such a way as to hold workpiece model WM24 serving as the reference at the position of the tool tip point T set on hand model 30M.

Returning to FIG. 3, next, the hand-workpiece holding position setting unit 116 sets a “position of each of workpiece models WM with respect to hand model 30M when workpiece models WM are held by hand model 30M”, based on
(a1) the quantity of workpiece models WM being collectively held,
(a2) workpiece model WM serving as a reference,
(a3) an interval between workpiece models WM conveyed along conveyance device model 80M, and
(a4) a position and a posture of robot model 20M when moving onto conveyance device model 80M (step S5).

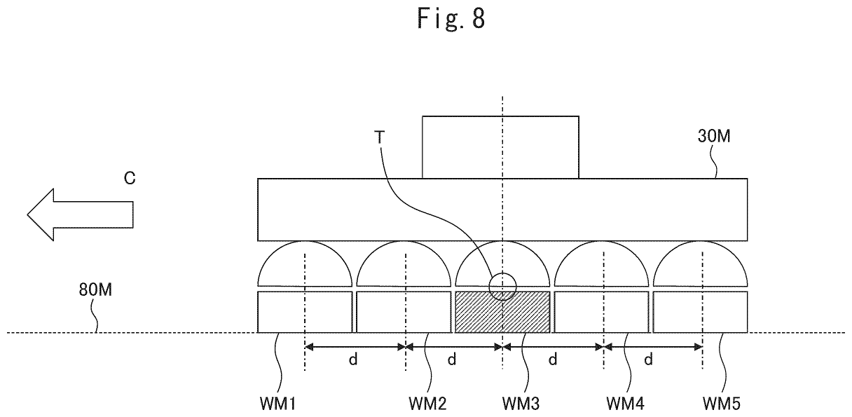

Herein, “(a1) the quantity of workpiece models WM being collectively held” and “(a2) workpiece model WM serving as a reference” are set in steps S3 and S4 described above. For “(a3) an interval between workpiece models WM conveyed along conveyance device model 80M”, as illustrated in FIG. 8, an interval d in the conveyance direction between workpiece models WM arranged continuously in the conveyance direction on conveyance device model 80M is designated. The plurality of workpiece models are assumed to be conveyed in a state where they are arranged at constant intervals. An operator may set, as the interval d, an interval equal to an interval between the plurality of adsorption portions of hand model 30M via the setting function provided by workpiece interval designation unit 123. With the interval d, the position on conveyance device model 80M of the other workpiece model WM (the workpiece models WM1 to WM2 and WM4 to WM5 in FIG. 8) with reference to the position of workpiece model WM (workpiece model WM3 in FIG. 8) serving as a reference can be obtained.

“(a3) An interval between workpiece models WM conveyed along conveyance device model 80M” may be preset in the storage unit 122.

Simulation execution unit 113 may obtain “(a4) a position and a posture of robot model 20M when moving onto conveyance device model 80M”, based on, for example, motion models as follows.
(k1) Robot model 20M starts a motion from a predetermined standby position in response to reception of, from detection device model 70M, a detection signal indicating that workpiece model WM serving as the reference is put onto conveyance device model 80M.
(k2) Robot model 20M moves in such a way as to track a movement (i.e., to follow a conveyance speed of conveyance device model 80M) in the conveyance direction of workpiece model WM serving as the reference in the tracking operation range (the range indicated by the arrow 81 in FIG. 4).
(k3) In a state where robot model 20M tracks the movement of workpiece model WM in the tracking operation range, the relative speed with respect to each other is zero. In this state, when a dynamic coordinate system moving at the conveyance speed is assumed, robot model 20M can perform a motion in such a way as to go down from above with respect to a stationary workpiece model and approach and hold the workpiece model.
(k4) In the motion described above, robot model 20M may perform a motion in such a way as to hold workpiece model WM serving as the reference by the adsorption portion located at a position of the tool tip point T of hand model 30M.

By executing a numerical simulation by the motion models (k1) to (k4) as described above, hand-workpiece holding position setting unit 116 can obtain, as “(a4) a position and a posture of robot model 20M when moving onto conveyance device model 80M”, a position and a posture of robot model 20M when robot model 20M is positioned in a position in which the plurality of workpiece models including workpiece model WM serving as the reference can be collectively held.

Hand-workpiece holding position setting unit 116 calculates a “position of each of workpiece models WM with respect to hand model 30M when workpiece models WM are held by hand model 30M”, based on “(a4) a position and a posture of robot model 20M when moving onto conveyance device model 80M” obtained as described above. The position of the tool tip point T is already known. Further, a position of workpiece model WM serving as the reference in the virtual space when robot model 20M is in the state of “(a4) a position and a posture of robot model 20M when moving onto conveyance device model 80M” can be acquired from a detection result by detection device model 70M and information about a conveyance speed and the like of conveyance device model 80M. Further, the interval d between workpiece models WM is already known as described above. Therefore, hand-workpiece holding position setting unit 116 can calculate a “position of each of workpiece models WM with respect to hand model 30M when workpiece models WM are held by hand model 30M”, based on the information of (a1) to (a4) described above. It should be noted that a “position of each of workpiece models WM with respect to hand model 30M when workpiece models WM are held by hand model 30M” can also be expressed as a “holding position of workpiece model WM with respect to hand model 30M”.

By the operation described above (steps S1 to S5), a “position of each of workpiece models WM with respect to hand model 30M when workpiece models WM are held by hand model 30M” is calculated and set in robot simulation device 10. In this way, the motion of collectively holding the plurality of workpiece models WM by robot model 20M can be displayed on a simulation screen. An operator can check whether robot model 20M can reach a position in which workpiece models WM can be properly collectively held, correct various setting contents as necessary, and create an appropriate program.

Further, according to the operation described above (steps S1 to S5), by a simple setting operation of inputting setting items of (a1) to (a3) described above, a user can cause robot simulation device 10 to execute a highly advanced simulation in which the plurality of workpiece models are collectively held. In other words, the present embodiment establishes a setting method beneficial to a user for executing a simulation of the motion of collectively holding the plurality of workpiece models WM by robot model 20M.

As illustrated in FIG. 3, the robot simulation device 10 can further perform operations indicated in steps S6 to S7 by using a “position of each of workpiece models WM with respect to hand model 30M when workpiece models WM are held by hand model 30M”.

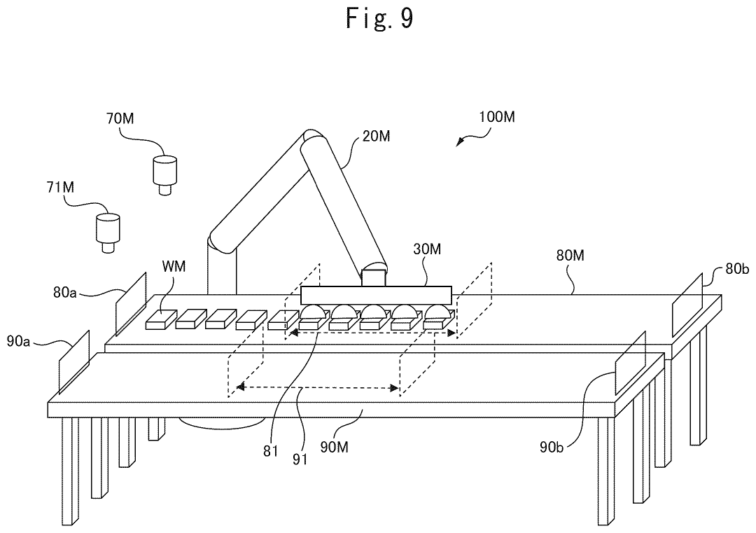

In step S6, robot simulation device 10 moves robot model 20M onto conveyance device model 80M, and causes robot model 20M to perform a motion of collectively holding workpiece models WM by hand model 30M, based on “(a4) the position and the posture of robot model 20M when moving onto conveyance device model 80M” and the “position of each of workpiece models WM with respect to hand model 30M when workpiece models WM are held by hand model 30M”. Specifically, as illustrated on a simulation screen in FIG. 9, simulation execution unit 113 moves robot model 20M in such a way that robot model 20M is in the state of “(a4) the position and the posture of robot model 20M when moving onto conveyance device model 80M”.

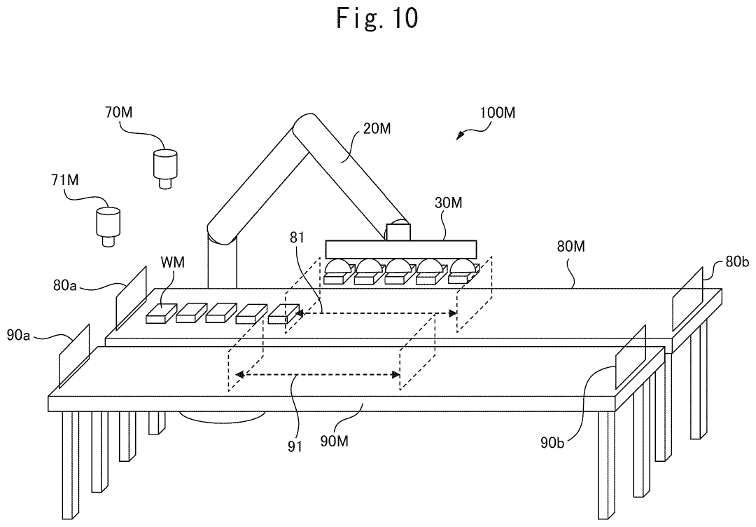

Then, the supply-device-workpiece erasing unit 117 erases, on conveyance device model 80M, workpiece models WM collectively held by hand model 30M. Further, hand-workpiece display unit 118 displays workpiece models WM on hand model 30M. Hand-workpiece display unit 118 can display workpiece models WM on hand model 30M according to the “position of each of workpiece models WM with respect to hand model 30M when workpiece models WM are held by hand model 30M”. FIG. 10 is a simulation screen illustrating a state where workpiece models WM have moved on hand model 30M side through these pieces of processing. It should be noted that FIG. 10 illustrates a state where robot model 20M is located in a position moved slightly upward from a position for holding workpiece models WM.

By the operation described above, the motion of robot model 20M of collectively holding, by hand model 30M, the plurality of workpiece models WM conveyed on conveyance device model 80M is expressed on the virtual space (display screen).

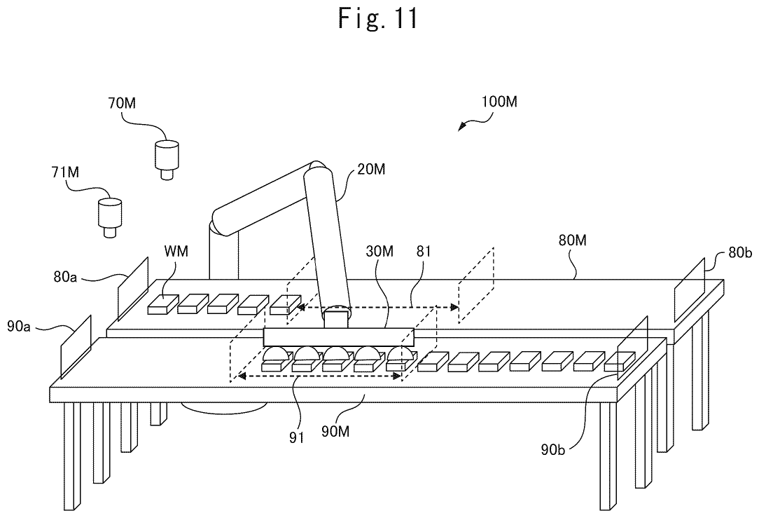

Next, in step S7, robot simulation device 10 moves robot model 20M onto conveyance device model 90M, and causes robot model 20M to perform a motion of arranging workpiece models WM on conveyance device model 90M, based on “(a4) the position and the posture of robot model 20M when moving onto conveyance device model 80M” and the “position of each of workpiece models WM with respect to hand model 30M when workpiece models WM are held by hand model 30M”. Specifically, as illustrated in FIG. 11, simulation execution unit 113 moves robot model 20M onto conveyance device model 90M, based on “(a4) the position and the posture of robot model 20M when moving onto conveyance device model 80M”. In this case, simulation execution unit 113 causes robot model 20M to perform a motion in such a way that, for example,
(k11) from the position and the posture of robot model 20M holding workpiece models WM as in FIG. 9,
(k12) robot model 20M can arrange workpiece models WM on a conveyance surface while following a conveyance speed of conveyance device model 90M in the following motion range (arrow 91) of conveyance device model 90M.

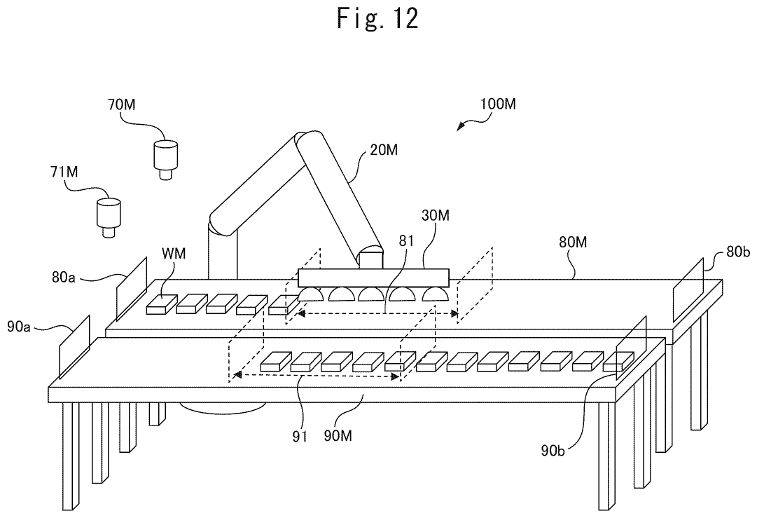

Next, discharge-device-workpiece display unit 119 displays workpiece models WM on conveyance device model 90M on a discharge side. Discharge-device-workpiece display unit 119 can arrange workpiece models WM on conveyance device model 90M according to the “position of each of workpiece models WM with respect to hand model 30M when workpiece models WM are held by hand model 30M”. Further, hand-workpiece erasing unit 120 erases workpiece models WM on hand model 30M. FIG. 12 is a simulation screen illustrating a state where workpiece models WM have moved on conveyance device model 90 side through these pieces of processing.

By the operation described above, the motion of robot system model 100M of collectively moving, by hand model 30M, the plurality of workpiece models WM from conveyance device model 80M on a supply side to conveyance device model 90M on the discharge side can be expressed on the virtual space (display screen).

Therefore, by the workpiece picking-up operation described above, a simulation of the robot system for collectively holding, by the hand model, the plurality of workpiece models conveyed on the conveyance device model can be achieved.

Hereinafter, two examples of modification examples of the embodiment described above will be described.

### Modification Example 1

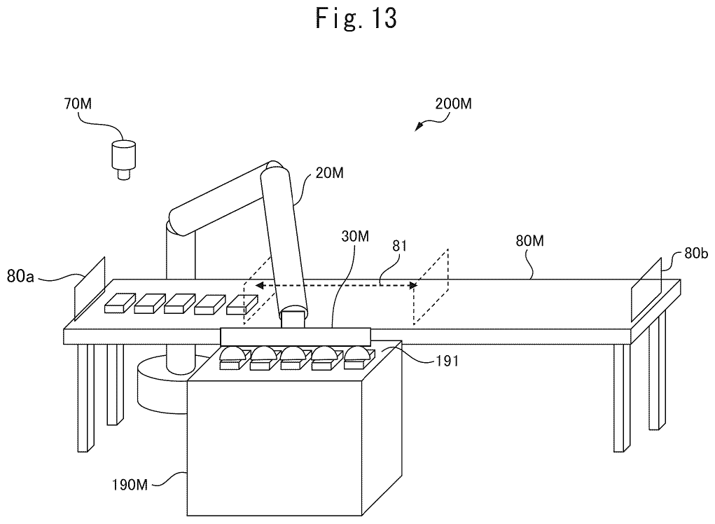

Modification Example 1 described herein is a configuration example of a case where a discharge device is a fixed stand. FIG. 13 illustrates a configuration of robot system model 200M according to Modification Example 1. Robot system model 200M includes fixed stand model 190M as a discharge device. In FIG. 13, the same component as the component of the robot system model 100M in the embodiment described above is provided with the same reference sign, and description thereof is omitted or simplified.

Robot simulation device 10 executes the processing in steps S1 to S5 of the workpiece picking-up operation described above (FIG. 3), and calculates and sets a “position of each of workpiece models WM with respect to hand model 30M when workpiece models WM are held by hand model 30M”.

Fixed-stand-workpiece arrangement position setting unit 121 sets an arrangement position of workpiece model WM with respect to fixed stand model 190M, based on
a position of each of workpiece models WM with respect to hand model 30M when workpiece models WM are held by hand model 30M, and
a position and a posture of robot model 20M when moving onto fixed stand model 190M.

In this case, simulation execution unit 113 may obtain “a position and a posture of robot model 20M when moving onto fixed stand model 190M”, based on, for example, motion models as follows. Robot model 20M is caused to perform a motion in such a way that,
(k21) from the position and the posture of robot model 20M holding workpiece models WM as in FIG. 9,
(k22) robot model 20M can move to a standby position above a placement surface 191 of fixed stand model 190M, go down from the standby position to approach the placement surface 191, and arrange all of workpiece models WM.

In this way, fixed-stand-workpiece arrangement position setting unit 121 can obtain “the position and the posture of robot model 20M when moving onto fixed stand model 190M”. An “arrangement position of workpiece model WM with respect to fixed stand model 190M” is acquired from “the position and the posture of robot model 20M when moving onto fixed stand model 190M” and the “position of each of workpiece models WM with respect to hand model 30M when workpiece models WM are held by hand model 30M”.

In this way, fixed-stand-workpiece arrangement position setting unit 121 can express, as a simulation image, the motion of arranging workpiece models WM held by robot model 20M on fixed stand model 190M as illustrated in FIG. 13.

It should be noted that, also in a case of the present example, robot simulation device 10 may perform the operations corresponding to steps S6 and S7 in the workpiece picking-up operation described above. In other words, when hand model 30M reaches a position in which hand model 30M holds workpiece models WM on conveyance device model 80M, supply-device-workpiece erasing unit 117 erases workpiece models WM on conveyance device model 80M. Then, hand-workpiece display unit 118 displays workpiece models WM on hand model 30M.

Next, when robot model 20M (hand model 30M) reaches a position in which robot model 20M arranges workpiece models WM on fixed stand model 190M, hand-workpiece erasing unit 120 erases workpiece models WM on hand model 30M. Then, discharge-device-workpiece display unit 119 displays workpiece models WM in an arrangement position of workpiece models WM.

In this way, a situation where workpiece models WM are held on conveyance device model 80M and are moved onto fixed stand model 190M is provided as a simulation image.

### Modification Example 2

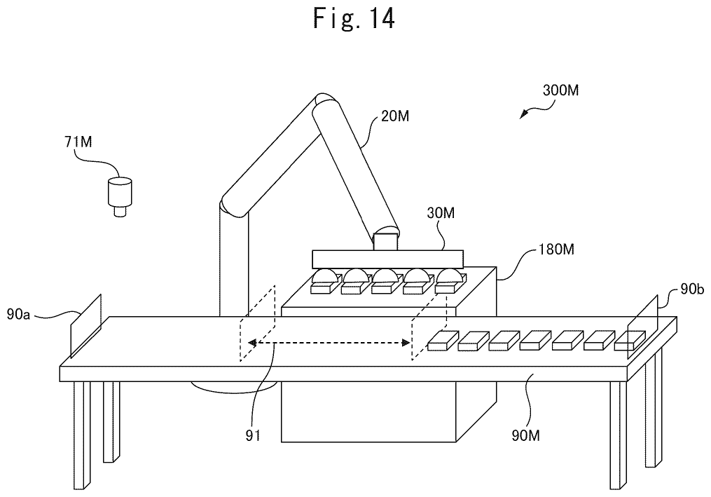

Next, as Modification Example 2, a configuration in a case where a supply device is a fixed stand and a discharge device is a conveyance device will be described with reference to FIG. 14. FIG. 14 illustrates a configuration of robot system model 300M according to Modification Example 2. Robot system model 300M includes fixed stand model 180M as a supply device. In FIG. 14, the same component as the component of robot system model 100M in the embodiment described above is provided with the same reference sign, and description thereof is omitted or simplified. Robot simulation device 10 can also simulate the operation when a supply device is a fixed stand and a discharge device is a conveyance device.

Three-dimensional model arrangement unit 112 arranges robot system model 300M including robot model 20M on the virtual space, and displays robot system model 300M on the display screen.

Next, workpiece holding quantity designation unit 114 accepts designation of the quantity of workpiece models being collectively held.

Further, reference workpiece designation unit 115 accepts designation of a workpiece model serving as a reference. In this case, a user may designate a specific workpiece model arranged on fixed stand model 180M as the workpiece model serving as the reference.

Robot simulation device 10 sets a “position of each of workpiece models WM with respect to hand model 30M when workpiece models WM are held by hand model 30M”, based on
(b1) the quantity of the workpiece models being collectively held,
(b2) the workpiece model serving as a reference,
(b3) an interval between the workpiece models, and
(b4) a position and a posture of robot model 20M when moving to fixed stand model 180M.

With regard to “(b3) an interval between the workpiece models”, a value of an interval between the plurality of adsorption pads of hand model 30M may be set similarly to the case described with reference to FIG. 8.

Simulation execution unit 113 may obtain “(b4) a position and a posture of robot model 20M when moving to fixed stand model 180M”, based on, for example, motion models as follows.
(k31) Robot model 20M moves from a predetermined standby position to an approach start position above workpiece models WM on fixed stand model 180M.
(k32) Robot model 20M goes down from the approach start position, and moves to a position in which workpiece models WM can be held.
(k33) In the motion described above, robot model 20M may perform a motion in such a way as to hold workpiece model WM serving as the reference by the adsorption portion located in a position of the tool tip point T of hand model 30M.

By executing a numerical simulation by the motion models as described above, hand-workpiece holding position setting unit 116 can obtain, as “(b4) a position and a posture of robot model 20M when moving to fixed stand model 180M”, a position and a posture of robot model 20M when robot model 20M is positioned in a position in which workpiece models WM can be held on fixed stand model 180M.

Hand-workpiece holding position setting unit 116 calculates a “position of each of workpiece models WM with respect to hand model 30M when workpiece models WM are held by hand model 30M”, based on “(b4) the position and the posture of robot model 20M when moving to fixed stand model 180M” obtained as described above. The position of the tool tip point T is already known. Further, the position of workpiece model WM serving as the reference in the virtual space when robot model 20M is in the state of the position and the posture of (b4) described above is already known. Further, the interval between workpiece models WM is already known as described above. Therefore, hand-workpiece holding position setting unit 116 can calculate the “position of each of workpiece models WM with respect to hand model 30M when workpiece models WM are held by hand model 30M”, based on the information of (b1) to (b4) described above.

Robot simulation device 10 (simulation execution unit 113) can also simulate a motion of moving robot model 20M onto conveyance device model 90M, based on “(b4) a position and a posture of robot model 20M when moving to fixed stand model 180M” and a “position of each of workpiece models WM with respect to hand model 30M when workpiece models WM are held by hand model 30M”. In this case, simulation execution unit 113 causes robot model 20M to perform a motion in such a way that, for example,
(k41) from the position and the posture of robot model 20M holding workpiece models WM as in FIG. 14,
(k42) robot model 20M can arrange workpiece models WM on the conveyance surface while following a conveyance speed of conveyance device model 90M in the tracking operation range (arrow 91) of conveyance device model 90M.

As described above, a simulation of a motion of collectively holding the plurality of workpiece models WM on fixed stand model 190M by hand model 30M and moving the plurality of workpiece models WM to the discharge device is achieved.

The functional block of the robot simulation device described with reference to FIG. 2 may be achieved by executing various types of software stored in the storage device by the CPU of the robot simulation device, or may be achieved by a configuration in which hardware such as an application specific integrated circuit (ASIC) is a main body.

The program for executing various types of processing such as the workpiece picking-up operation (FIG. 3) in the embodiment described above can be recorded in various computer-readable recording media (for example, a ROM, an EEPROM, a semiconductor memory such as a flash memory, a magnetic recording medium, and an optical disk such as a CD-ROM and a DVD-ROM).

As described above, according to the present embodiment, the operation of a robot system of collectively holding, by a three-dimensional model of a hand, three-dimensional models of a plurality of workpieces on a three-dimensional model of a supply device can be displayed on a virtual space (display screen). Further, a setting method beneficial to a user for executing a simulation of the robot system for collectively holding, by the three-dimensional model of the hand, the three-dimensional models of the plurality of workpieces on the three-dimensional model of the supply device can be established.

Although the present disclosure has been described above in detail, the present disclosure is not limited to the individual embodiments described above. Various types of addition, replacement, modification, partial deletion, and the like may be made to the embodiments without departing from the purpose of the present disclosure or without departing from the contents described in the claims and the scope of the present disclosure derived from equivalents thereof. Further, the embodiments can be performed in combination. For example, in the embodiments described above, an order of operations and an order of pieces of processing are indicated as one example, which is not limited thereto. Further, the same also applies to a case where a numerical value or a numerical expression is used in the description of the embodiments described above.

With regard to the embodiments and the modification examples described above, supplementary notes below are further described.

### Supplementary Note 1

A robot simulation device (10) including:
a three-dimensional model arrangement unit (112) configured to arrange, in a virtual space, a three-dimensional model of a robot, a three-dimensional model of a hand mounted on the robot, a three-dimensional model of a supply device, a three-dimensional model of a discharge device, a three-dimensional model of a workpiece, and a three-dimensional model of a detection device that detects the workpiece on the supply device;
a workpiece holding quantity designation unit (114) configured to accept an input for designating a quantity of the three-dimensional model of the workpiece collectively held by the three-dimensional model of the hand;
a reference workpiece designation unit (115) configured to accept an input for designating a three-dimensional model of a workpiece serving as a reference when the three-dimensional model of the workpiece is held by the three-dimensional model of the hand; and
a holding position setting unit (116) configured to set a holding position of the three-dimensional model of the workpiece with respect to the three-dimensional model of the hand when the three-dimensional model of the workpiece is held by the three-dimensional model of the hand, based on the designated quantity of the three-dimensional model of the workpiece being collectively held, the three-dimensional model of the workpiece serving as the reference, an interval between three-dimensional models of workpieces on the three-dimensional model of the supply device, and a position and a posture of the three-dimensional model of the robot when moving onto the three-dimensional model of the supply device.

### Supplementary Note 2

The robot simulation device (10) according to supplementary note 1, further including
a simulation execution unit (113) configured to move the three-dimensional model of the robot to the three-dimensional model of the supply device, and causes the three-dimensional model of the robot to perform a motion of collectively holding the three-dimensional models of the workpieces by the three-dimensional model of the hand, based on the position and the posture of the three-dimensional model of the robot when moving onto the three-dimensional model of the supply device, and the holding position of the three-dimensional model of the workpiece with respect to the three-dimensional model of the hand.

### Supplementary Note 3

The robot simulation device (10) according to supplementary note 2, wherein
the simulation execution unit (113) moves the three-dimensional model of the robot to the three-dimensional model of the supply device, erases the three-dimensional model of the workpiece on the three-dimensional model of the supply device, and displays the three-dimensional model of the workpiece on the three-dimensional model of the hand.

### Supplementary Note 4

The robot simulation device (10) according to supplementary note 2 or 3, wherein
the simulation execution unit (113) moves the three-dimensional model of the robot to the three-dimensional model of the discharge device, and causes the three-dimensional model of the robot to arrange the three-dimensional model of the workpiece on the discharge device, based on the position and the posture of the three-dimensional model of the robot when moving onto the three-dimensional model of the supply device, and the holding position of the three-dimensional model of the workpiece with respect to the three-dimensional model of the hand.

### Supplementary Note 5

The robot simulation device (10) according to supplementary note 4, wherein
the simulation execution unit (113) moves the three-dimensional model of the robot to the three-dimensional model of the discharge device, displays the three-dimensional model of the workpiece on the three-dimensional model of the discharge device, and erases the three-dimensional model of the workpiece on the three-dimensional model of the hand.

### Supplementary Note 6

The robot simulation device (10) according to any one of supplementary notes 1 to 5, wherein
the workpiece holding quantity designation unit (114) accepts a user input for designating the quantity of three-dimensional models of workpieces collectively held.

### Supplementary Note 7

The robot simulation device (10) according to any one of supplementary notes 1 to 6, wherein
the reference workpiece designation unit (115) accepts a user input for designating the workpiece serving as the reference.

### Supplementary Note 8

The robot simulation device (10) according to any one of supplementary notes 1 to 7, further including
a workpiece interval designation unit (123) configured to accept an input for designating the interval between the three-dimensional models of the workpieces on the three-dimensional model of the supply device.

### Supplementary Note 9

The robot simulation device (10) according to any one of supplementary notes 1 to 8, wherein
the supply device is a conveyance device, and the discharge device is a conveyance device.

### Supplementary Note 10

The robot simulation device (10) according to any one of supplementary notes 1 to 8, wherein
the supply device is a conveyance device, and the discharge device is a fixed stand.

### Supplementary Note 11

The robot simulation device (10) according to any one of supplementary notes 1 to 8, wherein
the supply device is a fixed stand, and the discharge device is a conveyance device.

### Supplementary Note 12

A robot simulation device (10) including:
a three-dimensional model arrangement unit (112) configured to arrange, in a virtual space, a three-dimensional model of a robot, a three-dimensional model of a hand mounted on the robot, a three-dimensional model of a supply device, a three-dimensional model of a discharge device, a three-dimensional model of a workpiece, and a three-dimensional model of a detection device that detects the workpiece on the supply device; and
a simulation execution unit (113) configured to,
based on a quantity of three-dimensional models of workpieces collectively held by the three-dimensional model of the hand, a three-dimensional model of a workpiece serving as a reference when the three-dimensional model of the workpiece is held by the three-dimensional model of the hand, an interval between three-dimensional models of workpieces on the three-dimensional model of the supply device, a position and a posture of the three-dimensional model of the robot when moving onto the three-dimensional model of the supply device, and a holding position of the three-dimensional model of the workpiece with respect to the three-dimensional model of the hand when the three-dimensional model of the workpiece is held by the three-dimensional model of the hand,
move the three-dimensional model of the robot to the three-dimensional model of the supply device, erase the three-dimensional model of the workpiece on the three-dimensional model of the supply device, and display the three-dimensional model of the workpiece on the three-dimensional model of the hand, and
move the three-dimensional model of the robot to the three-dimensional model of the discharge device, display the three-dimensional model of the workpiece on the three-dimensional model of the discharge device, and erase the three-dimensional model of the workpiece on the three-dimensional model of the hand.

### REFERENCE SIGNS LIST

10 Robot simulation device
11 CPU
12 Display unit
13 Operation unit
111 Virtual space creation unit
112 Three-dimensional model arrangement unit
113 Simulation execution unit
114 Workpiece holding quantity designation unit
115 Reference workpiece designation unit
116 Hand-workpiece holding position setting unit
117 Supply-device-workpiece erasing unit
118 Hand-workpiece display unit
119 Discharge-device-workpiece display unit
120 Hand-workpiece erasing unit
121 Fixed-stand-workpiece arrangement position setting unit
122 Storage unit
123 Workpiece interval designation unit
20M Robot model
30M Hand model
70M, 71M Detection device model
80M, 90M Conveyance device model
WM Workpiece model
180M, 190M Fixed stand model
191 Placement surface
100M, 200M, 300M Robot system model

1. A robot simulation device comprising:
a three-dimensional model arrangement unit configured to arrange, in a virtual space, a three-dimensional model of a robot, a three-dimensional model of a hand mounted on the robot, a three-dimensional model of a supply device, a three-dimensional model of a discharge device, a three-dimensional model of a workpiece, and a three-dimensional model of a detection device that detects the workpiece on the supply device;
a workpiece holding quantity designation unit configured to accept an input for designating a quantity of three-dimensional models of workpieces collectively held by the three-dimensional model of the hand;
a reference workpiece designation unit configured to accept an input for designating a three-dimensional model of a workpiece serving as a reference when the three-dimensional model of the workpiece is held by the three-dimensional model of the hand; and
a holding position setting unit configured to set a holding position of the three-dimensional model of the workpiece with respect to the three-dimensional model of the hand when the three-dimensional model of the workpiece is held by the three-dimensional model of the hand, based on the designated quantity of the three-dimensional model of the workpiece being collectively held, the three-dimensional model of the workpiece serving as the reference, an interval between three-dimensional models of workpieces on the three-dimensional model of the supply device, and a position and a posture of the three-dimensional model of the robot when moving onto the three-dimensional model of the supply device.

2. The robot simulation device according to claim 1, further comprising
a simulation execution unit configured to move the three-dimensional model of the robot to the three-dimensional model of the supply device, and causes the three-dimensional model of the robot to perform a motion of collectively holding the three-dimensional models of the workpieces by the three-dimensional model of the hand, based on the position and the posture of the three-dimensional model of the robot when moving onto the three-dimensional model of the supply device, and the holding position of the three-dimensional model of the workpiece with respect to the three-dimensional model of the hand.

3. The robot simulation device according to claim 2, wherein
the simulation execution unit moves the three-dimensional model of the robot to the three-dimensional model of the supply device, erases the three-dimensional model of the workpiece on the three-dimensional model of the supply device, and displays the three-dimensional model of the workpiece on the three-dimensional model of the hand.

4. The robot simulation device according to claim 2, wherein
the simulation execution unit moves the three-dimensional model of the robot to the three-dimensional model of the discharge device, and causes the three-dimensional model of the robot to arrange the three-dimensional model of the workpiece on the discharge device, based on the position and the posture of the three-dimensional model of the robot when moving onto the three-dimensional model of the supply device, and the holding position of the three-dimensional model of the workpiece with respect to the three-dimensional model of the hand.

5. The robot simulation device according to claim 4, wherein
the simulation execution unit moves the three-dimensional model of the robot to the three-dimensional model of the discharge device, displays the three-dimensional model of the workpiece on the three-dimensional model of the discharge device, and erases the three-dimensional model of the workpiece on the three-dimensional model of the hand.

6. The robot simulation device according to claim 1, wherein
the workpiece holding quantity designation unit accepts a user input for designating the quantity of three-dimensional models of workpieces collectively held.

7. The robot simulation device according to claim 1, wherein
the reference workpiece designation unit accepts a user input for designating the workpiece serving as the reference.

8. The robot simulation device according to claim 1, further comprising
a workpiece interval designation unit configured to accept an input for designating the interval between the three-dimensional models of the workpieces on the three-dimensional model of the supply device.

9. The robot simulation device according to claim 1, wherein
the supply device is a conveyance device, and the discharge device is a conveyance device.

10. The robot simulation device according to claim 1, wherein
the supply device is a conveyance device, and the discharge device is a fixed stand.

11. The robot simulation device according to claim 1, wherein
the supply device is a fixed stand, and the discharge device is a conveyance device.

12. A robot simulation device comprising:
a three-dimensional model arrangement unit configured to arrange, in a virtual space, a three-dimensional model of a robot, a three-dimensional model of a hand mounted on the robot, a three-dimensional model of a supply device, a three-dimensional model of a discharge device, a three-dimensional model of a workpiece, and a three-dimensional model of a detection device that detects the workpiece on the supply device; and
a simulation execution unit configured to,
based on a quantity of three-dimensional models of workpieces collectively held by the three-dimensional model of the hand, a three-dimensional model of a workpiece serving as a reference when the three-dimensional model of the workpiece is held by the three-dimensional model of the hand, an interval between three-dimensional models of workpieces on the three-dimensional model of the supply device, a position and a posture of the three-dimensional model of the robot when moving onto the three-dimensional model of the supply device, and a holding position of the three-dimensional model of the workpiece with respect to the three-dimensional model of the hand when the three-dimensional model of the workpiece is held by the three-dimensional model of the hand,
move the three-dimensional model of the robot to the three-dimensional model of the supply device, erase the three-dimensional model of the workpiece on the three-dimensional model of the supply device, and display the three-dimensional model of the workpiece on the three-dimensional model of the hand, and
move the three-dimensional model of the robot to the three-dimensional model of the discharge device, display the three-dimensional model of the workpiece on the three-dimensional model of the discharge device, and erase the three-dimensional model of the workpiece on the three-dimensional model of the hand.
